(19) United States
(12) Patent Application Publication
(10) Pub. No.: US 2023/0167632 A1
(43) Pub. Date: Jun. 1, 2023

(54) JET REGULATOR FOR A SANITARY FAUCET AND SANITARY FAUCET HAVING SUCH A JET REGULATOR

(71) Applicant: Grohe AG, Hemer (DE)

(72) Inventor: Christian KUTSCH, Dortmund (DE)

(73) Assignee: Grohe AG, Hemer (DE)

(21) Appl. No.: 18/070,838

(22) Filed: Nov. 29, 2022

(30) Foreign Application Priority Data
Nov. 29, 2021 (DE) 102021131207.8

(51) Int. Cl. E03C 1/08; B05B 1/16

(52) U.S. Cl. CPC E03C 1/08; B05B 1/1618; E03C 2001/026

(57) ABSTRACT

A jet regulator (1) for a sanitary faucet (2) that contains a first spray plate (3) for dispensing the liquid as a laminar jet; and a second spray plate (4) for dispensing the liquid as a mist jet. Moreover, a sanitary faucet (2) having such a jet regulator (1) is proposed.

This invention relates to a jet regulator for a sanitary faucet and a sanitary faucet having such a jet regulator. Such sanitary faucets are used, in particular, to provide a liquid on demand at a sink or wash basin.

Sanitary faucets can have a jet regulator, through which the liquid can be dispensed as a laminar jet. Furthermore, such jet regulators can be designed in the manner of an aerator, through which air can be added to the liquid. However, dispensing the liquid as a laminar jet can result in high liquid consumption.

Therefore, the invention addresses the problem of solving at least a part of the issues described with reference to the prior art and, in particular, of providing a jet regulator for a sanitary faucet, which can reduce the liquid consumption of the liquid. Furthermore, a sanitary faucet having a jet regulator, which can be used to reduce the liquid consumption of the liquid, is to be specified.

These problems are solved by a jet regulator and a sanitary faucet having the features of the independent claims. Further advantageous embodiments of the invention are specified in the dependent claims. It will be appreciated that the features listed individually in the dependent claims may be combined in any technologically useful manner and define further embodiments of the invention. In addition, the features indicated in the claims are further specified and explained in the description, wherein further preferred embodiments of the invention are illustrated.

A jet regulator for a sanitary faucet, having at least the features listed below, contributes to solving the problem:
a first spray plate for dispensing the liquid as a laminar jet; and
a second spray plate for dispensing the liquid as a mist jet.

The jet regulator can be used in particular for a sanitary faucet, which is used to provide a liquid, in particular water or mixed water, for instance at a tap, a sink and/or a wash basin. The mixed water can be mixed by the sanitary faucet or a mixing valve of the sanitary faucet, in particular from cold water having a cold-water temperature and hot water having a hot-water temperature. The cold-water temperature is in particular at most 25° C. (Centigrade), preferably 1° C. to 25° C., particularly preferably 5° C. to 20° C. and/or the hot-water temperature is in particular at most 90° C., preferably 25° C. to 90° C., particularly preferably 55° C. to 65° C. The mixing cartridge can be disposed at least in part in a faucet body of the sanitary faucet. Furthermore, an actuating element can be used to actuate the mixing valve, in particular for setting a mixed-water temperature of the mixed water and/or for dispensing the mixed water. The actuating element can, for instance, be designed in the form of a lever or rotating element.

The jet regulator may, for instance, be of the mousseur or aerator type and/or be used to dispense the liquid to an environment of the sanitary faucet. The jet regulator may be (substantially) cylindrical in shape and/or extend along a longitudinal axis. In particular, the jet regulator may have a length of 5 mm to 50 mm in parallel to the longitudinal axis and/or a diameter of 5 mm to 50 mm (in particular orthogonal to the longitudinal axis). Furthermore, the jet regulator may be at least partially made of metal and/or plastic. The jet regulator, for instance, can be designed in the manner of a plastic die-cast component. In addition, the jet regulator can be disposed in particular at the sanitary faucet, at a faucet body of the sanitary faucet, at an outlet of the sanitary faucet or at a shower head of the sanitary faucet. In particular, the jet regulator can be arranged at and/or at least partially in an outlet opening of the sanitary faucet.

The jet regulator has a first spray plate for dispensing the liquid as a laminar jet. For instance, the first spray plate may serve to unify, broaden, and/or slow the liquid exiting the first spray plate. The laminar jet is in particular a liquid jet having a (substantially) laminar flow. For this purpose, the spray plate can have a plurality of flow channels that extend in parallel to one another and/or to the longitudinal axis of the jet regulator. The flow channels can, for instance, be designed in the manner of a flow rectifier. Furthermore, the laminar jet may be a full jet or a standard jet. In particular, the laminar jet consists of one single liquid jet. In particular, the laminar jet is not a rain jet formed by a plurality of individual jets. Furthermore, the laminar jet may have an annular cross-section, in particular orthogonal to the longitudinal axis. For this purpose, the first spray plate may have an annular first liquid dispensing port. For instance, it can have an inner diameter of 1 mm (millimeter) to 15 mm and/or an outer diameter of 5 mm to 40 mm. In particular, the first spray plate is designed such that the liquid exits the first spray plate at a liquid pressure of 3 bar at a first liquid volume of 7 l/min (liters per minute) to 11 l/min, preferably 8.5 l/min to 9.5 l/min, particularly preferably (substantially) 9 l/min.

Furthermore, the jet regulator has a second spray plate for dispensing the liquid as a mist jet. To this end, the second spray plate may, in particular, atomize the liquid as it is dispensed and/or dispense it in a plurality of droplets, which may, for instance, have an average droplet diameter of 10 μm (micrometers) to 500 μm. In particular, all of the liquid delivered via the second spray plate can be delivered as a mist jet. In particular, the second spray plate is designed such that the liquid exits the second spray plate at a liquid pressure of 3 bar at a second liquid volume of 0.1 l/min to 0.6 l/min (liters per minute). If a (full) laminar jet is not required, dispensing the liquid as a mist jet can reduce the liquid consumption of the liquid.

The first spray plate may at least partially encompass the second spray plate in an annular manner. For instance, the second spray plate can be at least partially disposed within the first spray plate. For this purpose, the first spray plate can, for instance, have a mount for the second spray plate. The first spray plate and the second spray plate are arranged in particular coaxially to each other.

The second spray plate can be designed in the manner of a nozzle. In particular, the second spray plate has a single nozzle. The nozzle may be at least partially funnel-shaped and/or taper toward a nozzle opening or a second liquid dispensing opening of the second spray plate. The nozzle orifice or second liquid dispensing orifice may have (in particular orthogonal to the longitudinal axis of the jet regulator or second spray plate) a circular cross-section and/or a diameter (in particular orthogonal to the longitudinal axis of the jet regulator or second spray plate) of 10 μm (micrometer) to 500 μm.

The second spray plate may include a nozzle element and a feed element. This can mean, for instance, that the spray plate is (only) formed from two parts. In particular, the nozzle is formed in the nozzle element. The feed element may at least partially form and/or delimit an inlet chamber of the second spray plate. The liquid in particular can be fed to the second spray plate via the inlet chamber.

The nozzle element and the feed element may be inserted into the first spray plate from opposite directions. In particular, the nozzle element and the feed element may be inserted into the first spray plate in parallel to the longitudinal axis of the jet regulator.

In accordance with another aspect, a sanitary faucet is also proposed, comprising at least the components listed below:
a faucet body; and
a jet regulator according to the invention.

The faucet body can at least partially be made of plastic and/or metal, such as brass or a zinc alloy. Further, the faucet body can be attached to a support, such as a countertop, the sink, or the wash basin. In addition, the faucet body can have a (protruding or branching) outlet that is rigidly or movably connected to the faucet body. The outlet can be formed to be at least partially tubular. In addition, the outlet can be at least partially formed by a helical spring. Further, the faucet body and/or outlet may have a decorative outer surface. The outlet may have an opening that, in particular, connects an interior of the outlet to an environment of the sanitary faucet. A hose can extend through the outlet, through which the liquid can be routed to the jet regulator.

The liquid can be routed to a second spray plate of the jet regulator via an inlet channel that opens into an inlet chamber of the second spray plate at an angle to a longitudinal axis of the second spray plate. As a result, the liquid can be routed to the second spray plate or the nozzle, in particular as a eddy current or swirled.

The sanitary faucet may include a valve for feeding liquid to either a first spray plate of the jet regulator or a second spray plate of the jet regulator. The valve can be designed in particular in the manner of a 2-way valve.

The sanitary faucet may have a changeover element for actuating the valve. In particular, the changeover element can also be designed in the manner of push button or a toggle element.

The changeover element can be arranged at the faucet body or a shower head of the sanitary faucet. The shower head can be designed in particular in the manner of a hand shower. Further, the changeover element may be at least partially disposed at an outer surface of the sanitary faucet, the faucet body, the outlet, or the shower head of the sanitary faucet. In this way, the changeover element can be actuated or contacted by a user of the sanitary faucet.

The invention and the technical environment are explained in more detail below with reference to the figures. It should be noted that the figures show particularly preferred variants of the embodiment variant of the invention, but the invention is not limited thereto. The same reference numerals are used for the same components in the figures. In an exemplary and schematic manner,

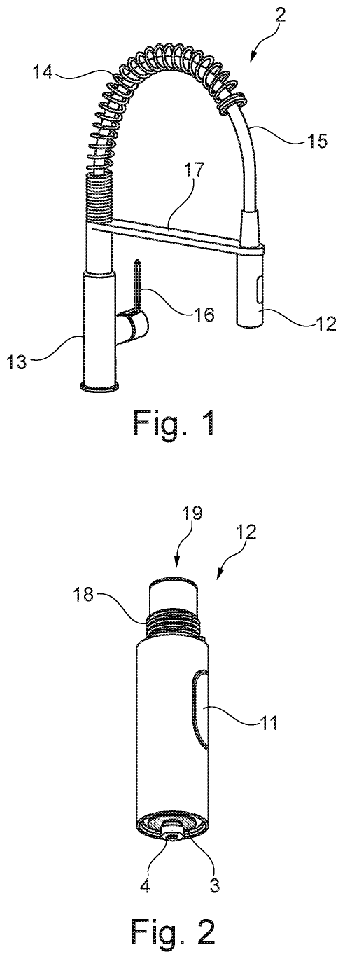

FIG. 1 shows a perspective view of a sanitary faucet;

FIG. 2 shows a shower head of the sanitary faucet;

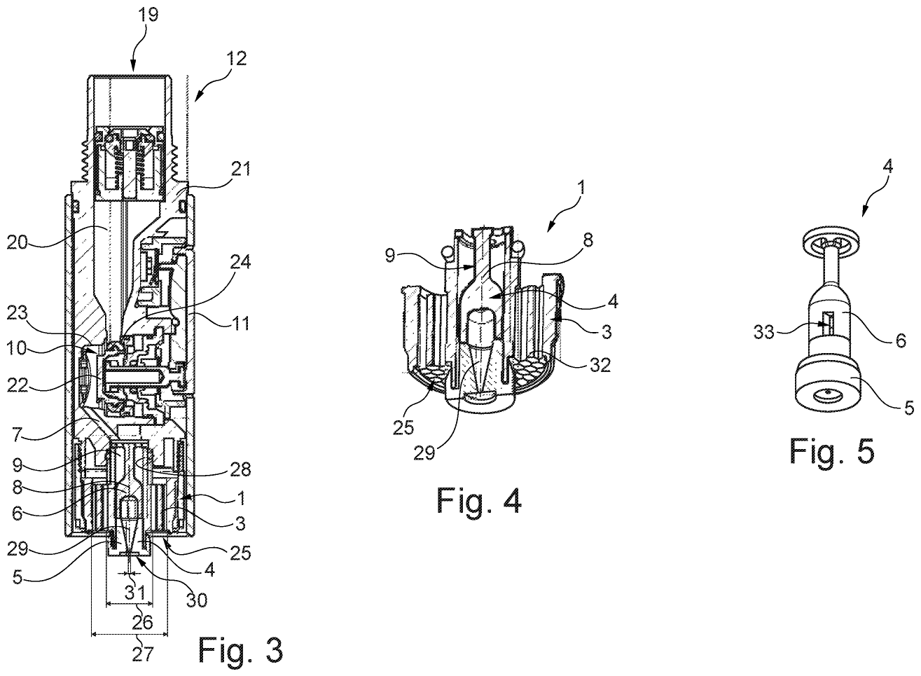

FIG. 3 shows a longitudinal section of the shower head having a first embodiment variant of a jet regulator;

FIG. 4 shows a longitudinal section of the first embodiment variant of the jet regulator;

FIG. 5 shows a perspective view of a second spray plate of the first embodiment variant of the jet regulator;

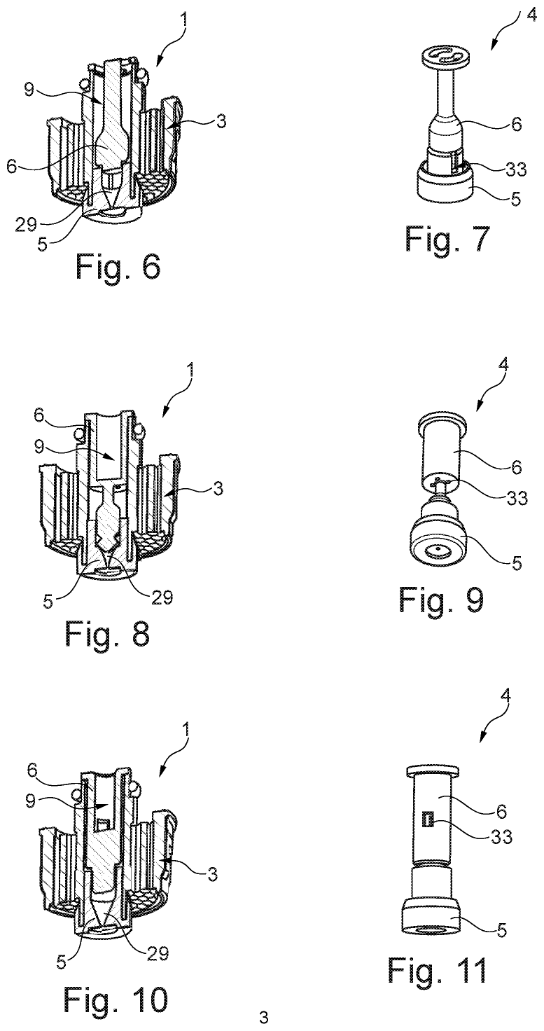

FIG. 6 shows a longitudinal section of a second embodiment variant of the jet regulator;

FIG. 7 shows a perspective view of a second spray plate of the second embodiment variant jet regulator;

FIG. 8 shows a longitudinal section of a third embodiment variant of the jet regulator;

FIG. 9 shows a perspective view of a second spray plate of the third embodiment variant of the jet regulator;

FIG. 10 shows a longitudinal section of a fourth embodiment variant of the jet regulator; and

FIG. 11 shows a perspective view of a second spray plate of the fourth embodiment variant of the jet regulator.

FIG. 1 shows a perspective view of the sanitary faucet 2. The sanitary faucet 2 has a faucet body 13 having a flexibly designed outlet 14. The faucet body 13 can be attached to a support not shown here, such as a sink. A flexible hose 15 extends through the outlet 14 and is connected to a shower head 12. A liquid or mixed water can be routed to the shower head 12 via the hose 15. An actuating element 16 of the sanitary faucet 2 can be used to control the dispensing of the liquid or the mixed water, wherein the actuating element 16 is designed in the manner of a lever. The shower head 12 is detachably attached to a bracket 17 of the faucet body 13.

FIG. 2 shows a perspective view of the shower head 12 of the sanitary faucet 2 of FIG. 1. The shower head 12 has an inlet 19 for the liquid having a thread 18, which can be used to attach the flexible hose 15 shown in FIG. 1 to the shower head 12. In addition, the shower head 12 includes a changeover element 11, which a user of the shower head 12 can use to choose between dispensing the liquid via a first spray plate 3 or a second spray plate 4.

FIG. 3 shows a longitudinal section of the shower head 12. Within a shower head body 21 of the shower head 12 the liquid can be routed from the inlet 19 to a valve 10 of the shower head 12 via a liquid channel 20. The valve 10 comprises a valve body 22 that can be adjusted between a first valve seat 23 and a second valve seat 24 by the changeover element 11. If the valve body 22 is located on the first valve seat 23, the liquid channel 20 is connected to the first spray plate 3 of a jet regulator 1, to be able to discharge the liquid via the first spray plate 3 as a laminar jet. A first liquid dispensing opening 25 of the first spray plate 3 has an annular cross-section having an inner diameter 26 and an outer diameter 27, i.e., the laminar jet has an annular cross-section at least immediately after being dispensed by the first spray plate 3. If the valve body 22 is located on the second valve seat 24, the liquid channel 20 is connected to the second spray plate 4 in a liquid-conveying manner, i.e., the liquid can be dispensed as a mist jet via the second spray plate 4. The second spray plate 4 is formed by a nozzle element 5 and a feed element 6, which are inserted from opposite directions into a cylindrical or tubular mount 28 of the first spray plate 3. The shower head 12 comprises an inlet channel 7, through which the liquid can be routed from the valve 10 into an inlet chamber 9 of the second spray plate 4. The inlet channel 7 opens into the inlet chambers 9 at an angle to a longitudinal axis 8 of the second spray plate 4, such that the liquid can flow through the inlet chambers 9 as an eddy current to a nozzle 29 of the nozzle element 5. The nozzle 29 tapers in parallel to the longitudinal axis 8 in the direction of a nozzle tip or second liquid dispensing opening 30 of the second spray plate 4. The second dispensing opening 30 has a diameter 31.

FIG. 4 shows a perspective longitudinal cross-section of the first embodiment variant of the jet regulator 1. The first spray plate 3 has a plurality of flow channels 32 extending in parallel to the longitudinal axis 8 of the second spray plate 4 or the jet regulator 1. There, the flow channels 32 are arranged closely together such that the liquid exits the first liquid dispensing opening 25 of the first spray plate 3 as a laminar jet.

FIG. 5 shows the second spray plate 4 having the nozzle element 5 and the feed element 6 of the first embodiment variant of the jet regulator 1 shown in FIGS. 3 and 4. The liquid flows as an eddy current through the inlet chamber 9 shown in FIGS. 3 and 4 along the feed element 6 and enters the nozzle 29 of the nozzle element 5 shown in FIGS. 3 and 4 as an eddy current through an opening 33 of the feed element 6, for the liquid to be delivered as a mist jet by the second spray plate 4.

FIG. 6 shows a perspective longitudinal cross-section of a second embodiment variant of the jet regulator 1, FIG. 8 shows a perspective longitudinal cross-section of a third embodiment variant of the jet regulator 1, and FIG. 10 shows a perspective longitudinal cross-section of a fourth embodiment variant of the jet regulator 1. The first spray plate 3 of the second and fourth embodiment variants of jet regulator 1 are formed identically to the first spray plate 3 of the first embodiment variant of the jet regulator 1 shown in FIGS. 3 and 4.

FIG. 7 shows a perspective view of the second spray plate 4 of the second embodiment variant of the jet regulator 1 shown in FIG. 6, FIG. 9 shows a perspective view of the second spray plate 4 of the third embodiment variant of the jet regulator 1 shown in FIG. 8, and FIG. 11 shows a perspective view of the second spray plate 4 of the fourth embodiment variant of the jet regulator 1 shown in FIG. 10. The second spray plate 4 of the second, third and fourth embodiment variants of the jet regulator 1 differ only slightly from the second spray plate 4 of the first embodiment variant of the jet regulator 1 shown in FIGS. 3 to 5. Also in the second, third and fourth embodiment variants of the jet regulator 1, the liquid flows as an eddy current through the inlet chambers 9 along the feed element 6 and enters the nozzle 29 of the nozzle element 5 shown in FIGS. 6, 8 and 10 as an eddy current via at least one opening 33 of the feed element 6 or of the nozzle element 5, for the liquid to be delivered as a mist jet by the second spray plate 4.

This invention reduces the liquid consumption of the liquid.

### LIST OF REFERENCE NUMERALS AND TERMS

1 jet regulator
2 sanitary faucet
3 first spray plate
4 second spray plate
5 nozzle element
6 feed element
7 inlet channel
8 longitudinal axis
9 inlet chamber
10 valve
11 changeover element
12 shower head
13 faucet body
14 outlet
15 hose
16 actuating element
17 bracket
18 thread
19 inlet
20 liquid channel
21 shower head body
22 valve body
23 first valve seat
24 second valve seat
25 first liquid dispensing opening
26 inner diameter
27 outer diameter
28 mount
29 nozzle
30 second liquid dispensing opening
31 diameter
32 flow channel
33 opening

1. A jet regulator (1) for a sanitary faucet (2), comprising at least:
a first spray plate (3) for dispensing the liquid as a laminar jet; and
a second spray plate (4) for dispensing the liquid as a mist jet.

2. The jet regulator (1) according to claim 1, wherein the first spray plate (3) at least partially encompasses the second spray plate (4) in an annular manner.

3. The jet regulator (1) according to claim 1, wherein the second spray plate (4) is designed in the manner of a nozzle (29).

4. The jet regulator (1) according to claim 1, wherein the second spray plate (4) comprises a nozzle element (5) and a feed element (6).

5. The jet regulator (1) according to claim 4, wherein the nozzle element (5) and the feed element (6) are inserted into the first spray plate (3) from opposite directions.

6. A sanitary faucet (2), comprising at least:
a faucet body (13); and
a jet regulator (1) according to claim 1.

7. The sanitary faucet (2) according to claim 6, wherein a liquid can be routed to a second spray plate (4) of the jet regulator (1) via an inlet channel (7) that opens into an inlet chamber (9) of the second spray plate (4) at an angle to a longitudinal axis (8) of the second spray plate (4).

8. The sanitary faucet (2) according to claim 6, comprising a valve (10), which can be used to route the liquid either to a first spray plate (3) of the jet regulator (1) or to a second spray plate (4) of the jet regulator (3).

9. The sanitary faucet (2) according to claim 6, comprising a changeover element (11) for actuating the valve (10).

10. The sanitary faucet (2) according to claim 9, wherein the changeover element (11) is disposed at the faucet body (13) or a shower head (12) of the sanitary faucet body (2).
